(19) United States
(12) Patent Application Publication
(10) Pub. No.: US 2025/0346160 A1
(43) Pub. Date: Nov. 13, 2025

(54) OCCUPANT SUPPORT

(71) Applicant: Faurecia Automotive Seating, LLC, Auburn Hills, MI (US)

(72) Inventors: Cedric KETELS, Auburn Hills, MI (US); Thibaut LECUYER, Chesterfield, MI (US); John TURSELL, Auburn Hills, MI (US); Jeff FITZGERALD, Auburn Hills, MI (US); Todd SIETING, Auburn Hills, MI (US)

(21) Appl. No.: 18/660,556

(22) Filed: May 10, 2024

(51) Int. Cl. B60N 2/14

(52) U.S. Cl. CPC B60N 2/146

(57) ABSTRACT

An occupant support for a vehicle includes a seat foundation fixed in position relative to a floor of the vehicle, a seat cushion adapted to support an occupant above the floor of the vehicle, and a cushion swivel system configured to control pivotable movement of the seat cushion relative to the seat foundation about a vertical pivot axis.

### BACKGROUND

The present disclosure relates to a vehicle, and particularly to a vehicle seat included in the vehicle. More particularly, the present disclosure relates to a vehicle seat that can move relative to the rest of the vehicle.

### SUMMARY

According to the present disclosure, an occupant support for a vehicle includes a seat foundation fixed in position relative to a floor of the vehicle, a seat cushion adapted to support an occupant above the floor of the vehicle, and a cushion swivel system configured to control pivotable movement of the seat cushion relative to the seat foundation about a vertical pivot axis.

In illustrative embodiments, the cushion swivel system includes a swivel catch coupled to the seat foundation in a fixed position relative to the seat foundation, a swivel latch coupled to the seat cushion for pivotable movement with the seat cushion, and a latch control system. The latch control system is configured to control movement of the swivel latch between a locked position engaged with the swivel catch to block rotation of the seat cushion about the vertical axis, and an unlocked position separated from the swivel catch so that the seat cushion is free to pivot about the vertical axis.

In illustrative embodiments, the latch control system includes an actuator unit, a latch retainer, and an actuator control unit. The actuator unit is coupled with the swivel latch and is configured to move the swivel latch from the locked position to the unlocked position. The latch retainer is configured to engage the swivel latch in the unlocked position to block movement of the swivel latch from the unlocked position to the locked position. The actuator control unit includes an interface configured to receive user inputs and a controller.

In illustrative embodiments, the controller is configured to output a first command to the actuator unit in response to a first user input to the interface to cause the actuator to move the swivel latch from the locked position to the unlocked position. The controller is configured to output a second command to the actuator unit in response to a second user input to the interface to cause the latch retainer to release the swivel latch so that the swivel latch can return to the locked position.

Additional features of the present disclosure will become apparent to those skilled in the art upon consideration of illustrative embodiments exemplifying the best mode of carrying out the disclosure as presently perceived.

### BRIEF DESCRIPTIONS OF THE DRAWINGS

The detailed description particularly refers to the accompanying figures in which:

FIG. 1 is a perspective and diagrammatic view of an occupant support including a seat foundation, a seat cushion, and a cushion swivel system in accordance with the present disclosure;

FIG. 2 is a perspective and diagrammatic view of the occupant support showing the seat cushion rotated about a vertical axis;

FIG. 3 is a top view of the occupant support with a portion of the seat cushion removed to show the cushion swivel system in a locked position blocking rotation of the seat cushion about the vertical axis;

FIG. 4 is a top view of the occupant support with a portion of the seat cushion removed to show the cushion swivel system in an unlocked position to allow rotation of the seat cushion about the vertical axis;

FIG. 5 is an enlarged perspective view of an actuator unit included in the cushion swivel system showing that the actuator unit includes an actuator mounted outside of a perimeter of the seat cushion and having an actuator piston configured to extend and retract to lock and unlock the seat cushion;

FIG. 6 is an enlarged perspective view actuator unit showing the actuator piston extended to unlock the seat cushion for pivotable movement about the vertical axis;

FIG. 7 is a top view of another embodiment of an actuator unit;

FIG. 8 is a top view of the actuator unit from FIG. 7 in an unlocked position;

FIG. 9 is a top view of the actuator unit from FIG. 7 in a locked position;

FIG. 10 is a top view of another embodiment of an actuator unit;

FIG. 11 is a top view of the actuator unit from FIG. 10 in an unlocked position;

FIG. 12 is a top view of the actuator unit from FIG. 10 in a locked position;

FIG. 13 is a top view of another embodiment of an actuator unit;

FIG. 14 is a top view of the actuator unit from FIG. 13 in an unlocked position;

FIG. 15 is a top view of the actuator unit from FIG. 13 in a locked position; and

FIG. 16 is a top view of another embodiment of an actuator unit.

### DETAILED DESCRIPTION

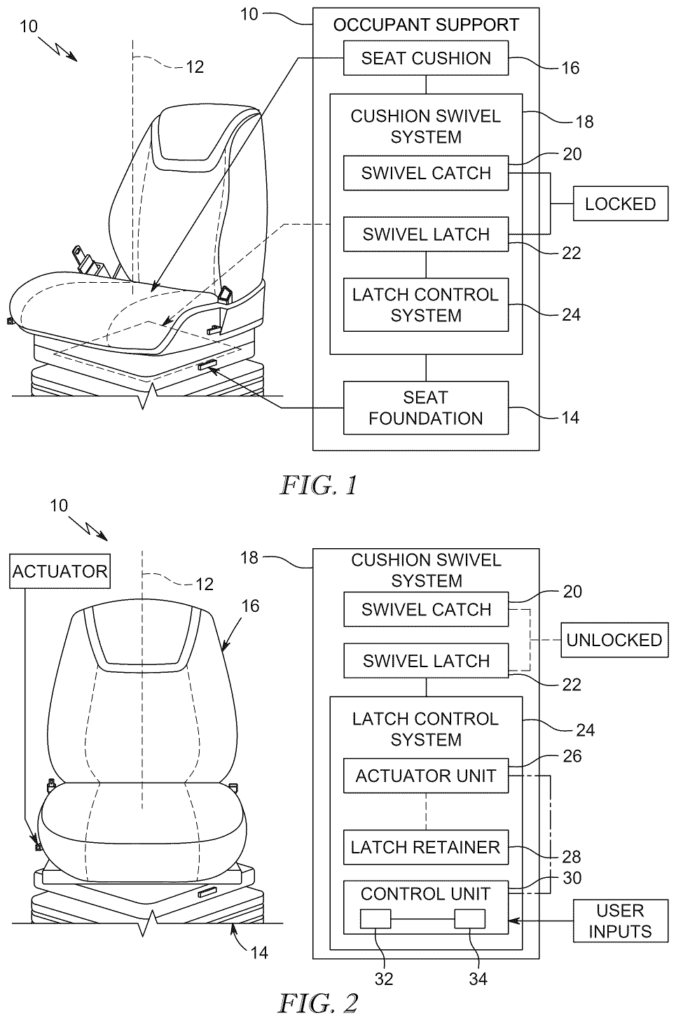

An occupant support 10, in accordance with the present disclosure, is configured to be attached to a vehicle and allow a seated occupant to swivel about a vertical pivot axis 12 as shown in FIGS. 1 and 2. The occupant support 10 includes a seat foundation 14 fixed in position relative to a floor of the vehicle, a seat cushion 16 adapted to support the occupant above the floor of the vehicle, and a cushion swivel system 18 configured to control pivotable movement of the seat cushion 16 relative to the seat foundation 14 about the vertical pivot axis 12.

The cushion swivel system 18 includes a swivel catch 20 coupled to the seat foundation 14 in a fixed position relative to the seat foundation 14, a swivel latch 22 coupled to the seat cushion 16 for pivotable movement with the seat cushion 16 about the pivot axis 12, and a latch control system 24 as shown in FIGS. 1 and 2. The latch control system 24 is configured to control movement of the swivel latch 22 between a locked position and an unlocked position. The swivel latch 22 engages the swivel catch 20 in the locked position to block rotation of the seat cushion 16 about the vertical axis 12. The swivel latch 22 separates from the swivel catch 20 in the unlocked position so that the seat cushion 16 is free to pivot about the vertical axis 12 relative to the seat foundation 14.

The latch control system 24 includes an actuator unit 26, a latch retainer 28, and an actuator control unit 30 as shown in FIG. 2. The actuator unit 26 is coupled to the seat cushion 16 for pivotable movement with the seat cushion 16 relative to the seat foundation 14. The actuator unit 26 is also coupled with the swivel latch 22 and is configured to move the swivel latch 22 relative to the seat cushion 16 from the locked position to the unlocked position. The latch retainer 28 is configured to engage the swivel latch 22 in the unlocked position to block movement of the swivel latch 22 from the unlocked position to the locked position. The actuator control unit 30 receives user inputs to control operation of the actuator unit 26 and the latch retainer 28 to lock or unlock the swivel latch 22 in response to the user inputs.

The actuator control unit 30 includes an interface 32 configured to receive the user inputs and a controller 34 configured to output commands in response to the inputs as shown in FIG. 2. The interface 32 may be coupled to the seat foundation 14, the seat cushion 16, or any other structure or location in the vehicle. The interface 32 may include one or more of buttons, sensors, switches, or any other suitable device that a user can interact with to provide the user inputs. The controller 34 includes one or more processors, a memory device storing instructions that are executed by the processor(s), and circuitry connecting the processor(s) to the memory and the controller 34 to the actuator unit 26.

The controller 34 is configured to receive signals from the interface 32 in response to the user inputs and is configured to output commands to the actuator unit 26 based on the signals. The commands include a first command to unlock the swivel latch 22, and a second command to lock the swivel latch. The first command causes the actuator unit 26 to move the swivel latch 22 from the locked position to the unlocked position. The second command causes the latch retainer 28 to release the swivel latch 22 so that the swivel latch 22 can return to the locked position.

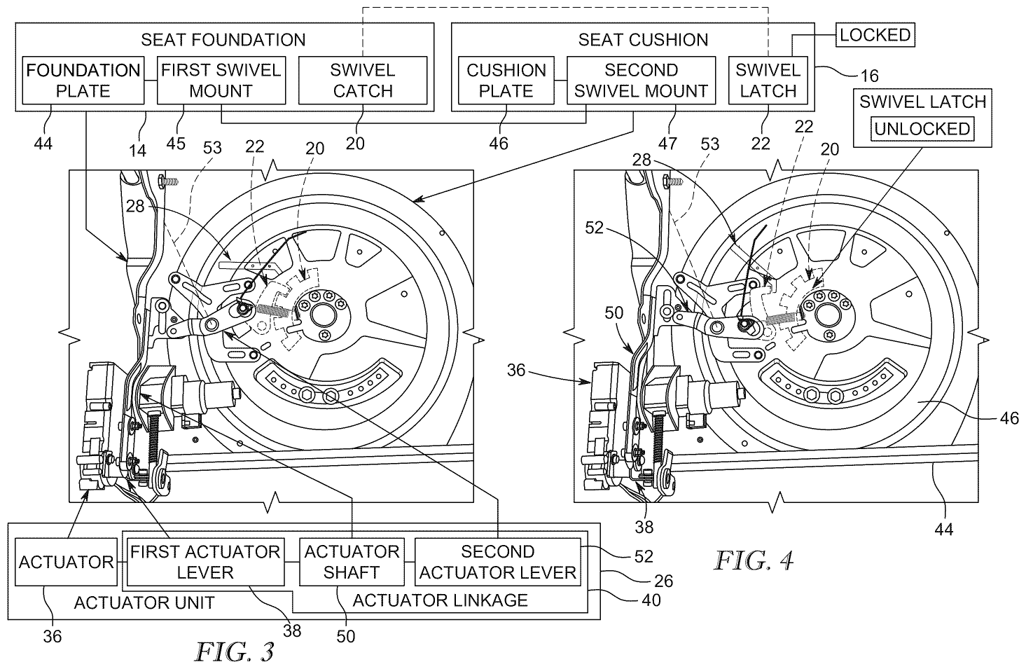

The actuator unit 26 includes an actuator 36 and actuator linkage 40 as shown in FIGS. 3 and 4. The actuator 36 is mounted to a side of the seat cushion 16 to reside outside of a perimeter of the seat cushion 16 defined by all sides of the seat cushion 16 and spaced radially from the vertical axis 12. The actuator linkage 40 interconnects the actuator 36 and the swivel latch 22 to transfer movement to the swivel latch 22 to change the swivel latch 22 from the locked position to the unlocked position in response to the first command.

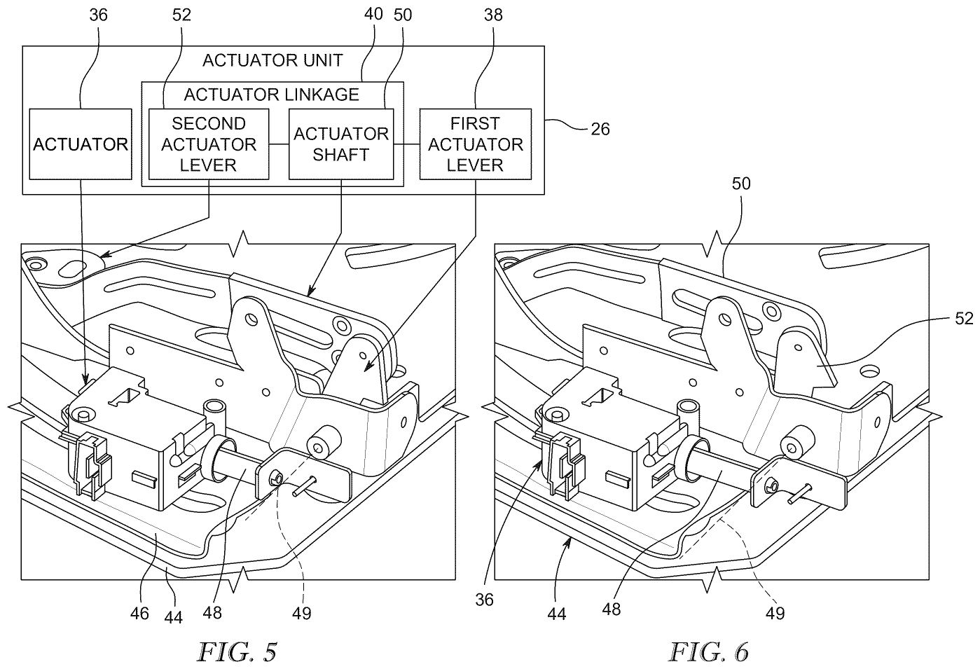

The actuator 36 is a linear actuator having an actuator piston 48 configured to engage the first actuator lever 38 as shown in FIGS. 5 and 6. The actuator piston 48 extends and retracts to cause movement of the actuator linkage 40 and the swivel latch in response to the first command and the second command. In some embodiments, the actuator 36 includes a radial actuator that exerts a torque or rotation on the actuator linkage 40 to cause the swivel latch to unlock.

The actuator linkage 40 includes a first actuator lever 38, an actuator shaft 50 coupled to the actuator lever 38 and a second actuator lever 52 coupled to the actuator shaft 50 and to the swivel latch 22 as shown in FIGS. 5 and 6. The first actuator lever 38 pivots about a first lever axis 49 in response to movement of the actuator piston 48. The actuator shaft 50 is configured to translate linearly relative to the seat cushion 16 in response to movement of the first actuator lever 36. The second actuator lever 52 is configured to pivot about a second lever axis 53 relative to the seat cushion 16 in response to movement of the actuator shaft 50 to cause pivotable movement of the swivel latch 22 to the unlocked position.

The seat foundation 14 includes a floor mount 42 and a foundation plate 44 coupled to the floor mount 42 as shown in FIGS. 1-4. The seat cushion 16 includes a cushion plate 46 that interfaces with the foundation plate 44 to provide a swivel interface therebetween. The actuator 36 is offset radially from the swivel interface relative to the vertical axis 12. The seat foundation 14 further includes a first swivel mount 45 and the seat cushion 16 further includes a second swivel mount 47 that interlocks with the first swivel mount 45 to support the seat cushion 16 on the seat foundation 14 when the swivel latch 22 is in the locked and unlocked positions. The first and second swivel mounts 45, 47 can include any suitable structure for supporting the seat cushion 16 on the seat foundation 14 while allowing the seat cushion 16 to swivel about axis 12 when the swivel latch 22 is in the unlocked position. The first and second swivel mounts 45, 47 can include one or more of a post, an aperture, a bearing, a rail, a slot, a channel, etc.

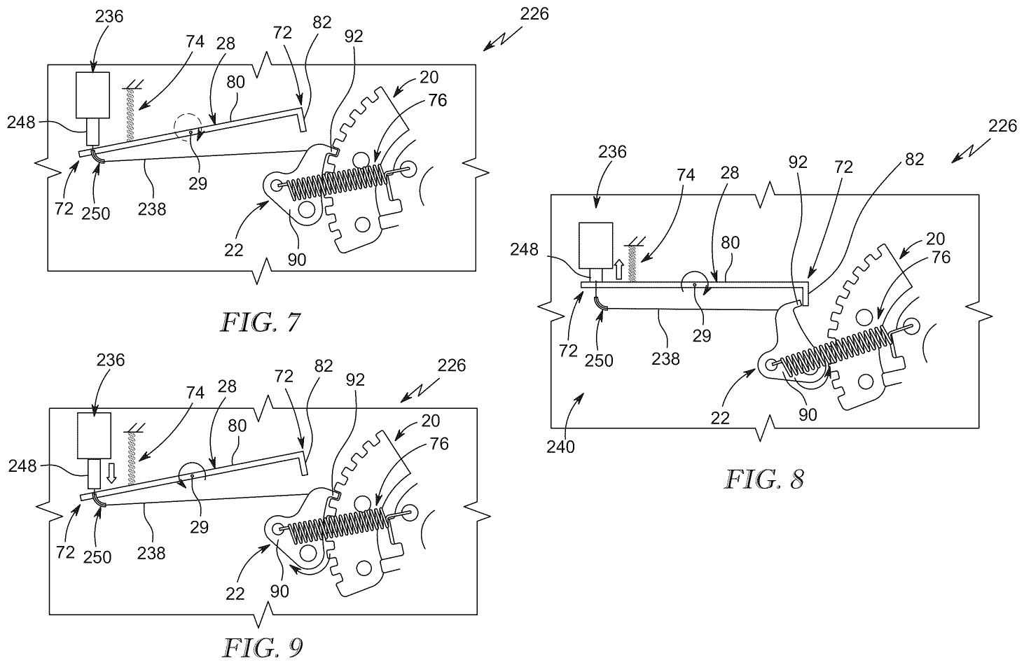

As shown in FIGS. 7-15, the latch retainer 28 includes a retainer body 80 and a retainer nose 82 coupled to an end of the retainer body 80 and arranged to lie at an angle relative to the retainer body 80. The swivel latch 22 includes a latch body 90 and a latch nose 92 configured to engage the latch catch 20 in the locked position to block movement of the seat cushion 16 relative to the seat foundation 14. The latch nose 92 is configured to engage the retainer nose 82 of the latch retainer 22 in the unlocked position to block movement of the swivel latch 22 from the unlocked position to the locked position. The retainer nose 92 separates from the swivel latch 22 in response to the second command so that the swivel latch 22 is free to return to the locked position by a return spring 76.

The latch retainer 28 blocks the swivel latch 22 from returning to the locked position until a user makes the second command to cause the latch retainer 28 to separate from the swivel latch 22. This allows the user to pivot freely about the vertical axis 12 to observe surroundings while the vehicle is in motion, for example. This can be useful in agricultural vehicles, construction vehicles, and/or autonomous vehicles.

Another embodiment of an actuator unit 226, in accordance with the present disclosure, is shown in FIGS. 7-9. The actuator unit 226 of FIGS. 7-9 can be used in place of actuator unit 26 of FIGS. 1-6, although portions of each latch control system 24, 224 can be combined. The disclosure of occupant support 10 is hereby incorporated herein for use with the actuator unit 226.

The actuator unit 226 includes an actuator 236 and actuator linkage 240 as shown in FIGS. 7-9. The actuator 236 is mounted to a side of the seat cushion 16 to reside outside of a perimeter of the seat cushion 16 defined by all sides of the seat cushion 16 and spaced radially from the vertical axis 12. The actuator linkage 240 interconnects the actuator 236 and the swivel latch 22 to transfer movement to the swivel latch 22 to change the swivel latch 22 from the locked position to the unlocked position in response to the first command.

The actuator 236 is a linear actuator having an actuator piston 248 configured to engage the actuator linkage 240 as shown in FIGS. 7-9. The actuator piston 248 extends and retracts to cause movement of the actuator linkage 240 and the swivel latch 22 in response to the first command and the second command.

The actuator linkage 240 includes an actuator cable 238 and a cable guide 250 as shown in FIGS. 7-9. The actuator cable 238 has a first end coupled to the actuator piston 248 and a second end coupled to the swivel latch 22. The cable guide 250 guides movement of the actuator cable 238 in response to movement of the actuator piston 248.

The actuator piston 248 is configured to move in a first direction to pull the actuator cable 238 in response to the first command to cause the swivel latch 22 to move to the unlocked position as shown in FIG. 8. The actuator piston 248 is configured to move in an opposite second direction in response to the second command to disengage the latch retainer 28 from the swivel latch 22 so that the swivel latch 22 is free to return to the locked position as shown in FIG. 9.

The latch retainer 28 includes a first end 70 configured to engage the swivel latch 22 in the unlocked position and an opposite second 72 end coupled to the linear piston 248 of the actuator 236. When the actuator piston 248 moves in the first direction to pull the actuator cable 238, the latch retainer 28 is biased to rotate about a retainer axis 29 to cause the first end 70 of the latch retainer 28 to engage the swivel latch 22 when the swivel latch 22 reaches the unlocked position. In the illustrative embodiment, a tension spring 74 is configured to pull the second end 72 of the latch retainer toward the actuator piston 248 so that the latch retainer pivots about the retainer axis 29 as the actuator piston 248 retracts.

When the actuator piston 248 moves in the second direction, the actuator piston 248 causes the latch retainer 28 to pivot about the retainer axis 29 in an opposite direction to cause the first end 70 to disengage the swivel latch 22. A return spring 76 is configured to bias the swivel latch 22 toward the locked position so that the swivel latch 22 returns to the locked position in response to the second command when the first end 70 disengages the swivel latch 22. Although the latch retainer 28 is shown with reference to FIGS. 7-9, it should be appreciated that the latch retainer 28 can be coupled to the actuator piston 48 for movement therewith in the same or similar manner.

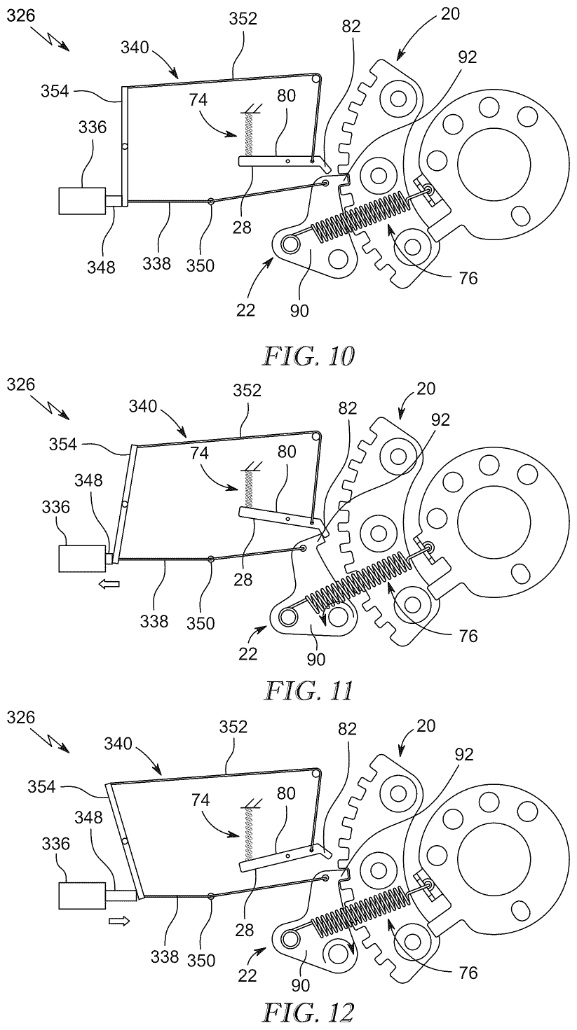

Another embodiment of an actuator unit 326, in accordance with the present disclosure, is shown in FIGS. 10-12. The actuator unit 326 of FIGS. 10-12 can be used in place of actuator unit 26 of FIGS. 1-6, although portions of each actuator unit 26, 326 can be combined. The disclosure of occupant support 10 is hereby incorporated herein for use with the actuator unit 326.

The actuator unit 326 includes an actuator 336 and actuator linkage 340 as shown in FIGS. 10-12. The actuator 336 is mounted to a side of the seat cushion 16 to reside outside of a perimeter of the seat cushion 16 defined by all sides of the seat cushion 16 and spaced radially from the vertical axis 12. The actuator linkage 340 interconnects the actuator 336 and the swivel latch 22 to transfer movement to the swivel latch 22 to change the swivel latch 22 from the locked position to the unlocked position in response to the first command.

The actuator 336 is a linear actuator having an actuator piston 348 configured to engage the actuator linkage 340 as shown in FIGS. 10-12. The actuator piston 348 extends and retracts to cause movement of the actuator linkage 340 and the swivel latch 22 in response to the first command and the second command.

The actuator linkage 340 includes an actuator cable 338 and a cable guide 350 as shown in FIGS. 10-12. The actuator cable 338 has a first end coupled to the actuator piston 348 and a second end coupled to the swivel latch 22. The cable guide 350 guides movement of the actuator cable 338 in response to movement of the actuator piston 348.

The actuator piston 348 is configured to move in a first direction to pull the actuator cable 338 in response to the first command to cause the swivel latch 22 to move to the unlocked position as shown in FIG. 11. The actuator piston 348 is configured to move in an opposite second direction in response to the second command to disengage the latch retainer 28 from the swivel latch 22 so that the swivel latch 22 is free to return to the locked position as shown in FIG. 12.

The actuator linkage 340 further includes a retainer cable 352 coupled to the latch retainer 28 as shown in FIGS. 10-12. The actuator piston 348 is configured to move in a second direction, opposite the first direction, in response to the second command to pull the retainer cable 352 to cause the latch retainer 28 to pivot about the retainer pivot axis 29 and disengage from the swivel latch 22. Although the latch retainer 28 is shown with reference to FIGS. 10-12, it should be appreciated that the latch retainer 28 can be coupled to the actuator piston 48 for movement therewith in the same or similar manner.

The actuator linkage 340 further includes an actuator lever 354 coupled to the seat cushion 16 for pivotable movement relative to the seat cushion 16 as shown in FIGS. 10-12. The actuator lever 354 has a first end coupled to the actuator piston 348 and to the actuator cable 338 to pull the actuator cable 338 in response to the first command and a second end coupled to the retainer cable 352 to pull the retainer cable 352 in response to the second command.

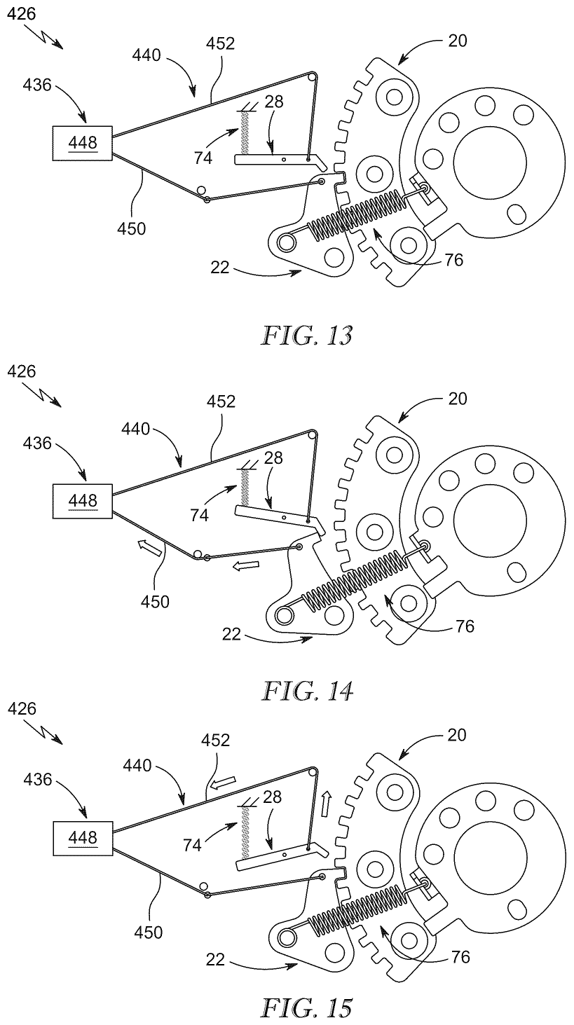

Another embodiment of an actuator unit 426, in accordance with the present disclosure, is shown in FIGS. 13-15. The actuator unit 426 of FIGS. 13-15 can be used in place of actuator unit 26 of FIGS. 1-6, although portions of each actuator unit 26, 426 can be combined. The disclosure of occupant support 10 is hereby incorporated herein for use with the actuator unit 426.

The actuator unit 426 includes an actuator 436 and actuator linkage 340 as shown in FIGS. 13-15. The actuator 336 is mounted to a side of the seat cushion 16 to reside outside of a perimeter of the seat cushion 16 defined by all sides of the seat cushion 16 and spaced radially from the vertical axis 12. The actuator linkage 440 interconnects the actuator 436 and the swivel latch 22 to transfer movement to the swivel latch 22 to change the swivel latch 22 from the locked position to the unlocked position in response to the first command and from the unlocked position to the locked position in response to the second command.

The actuator 436 includes a power source 448 and the actuator linkage 440 includes a first shape-memory alloy cable 450 and a second shape-memory alloy cable 452 as shown in FIGS. 13-15. The first and second shape-memory alloy cables 450, 452 are configured to retract or extend in response to electrical energy from the power source 448. The first shape-memory alloy cable 450 is coupled to the swivel latch 22. The second shape-memory alloy cable 452 is coupled to the latch retainer 28.

The power source 448 is configured to energize the first shape-memory alloy cable 450 to pull the swivel latch 22 to the unlocked position in response to the first command as shown in FIG. 14. The power source 448 is configured to energize the second shape-memory alloy cable 452 to separate the latch retainer 28 from the swivel latch in response to the second command so that the swivel latch 22 is free to return to the locked position as shown in FIG. 15.

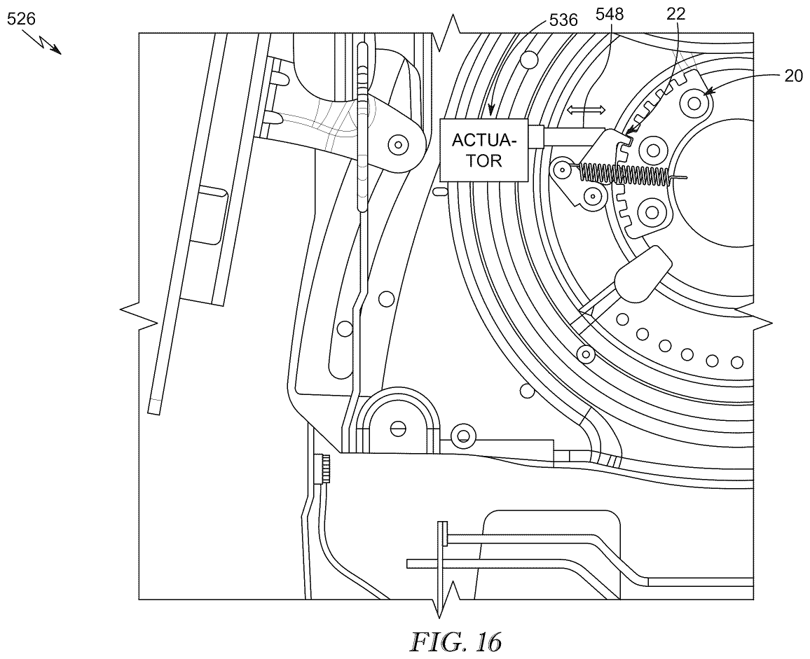

Another embodiment of an actuator unit 526, in accordance with the present disclosure, is shown in FIG. 16. The actuator unit 526 of FIG. 16 can be used in place of actuator unit 26 of FIGS. 1-6, although portions of each actuator unit 26, 526 can be combined. The disclosure of occupant support 10 is hereby incorporated herein for use with the actuator unit 526.

The actuator unit 526 includes a linear actuator having an actuator piston 548 that directly engages with the swivel latch 22 as shown in FIG. 16. The actuator piston 548 is configured to extend and retract to move the swivel latch 22 between the locked position and the unlocked position.

The following numbered clauses include embodiments that are contemplated and non-limiting:
Clause 1. An occupant support for a vehicle includes a seat foundation fixed in position relative to a floor of the vehicle.
Clause 2. The occupant support of clause 1, any other suitable clause, or any suitable combination of clauses, including a seat cushion adapted to support an occupant above the floor of the vehicle.
Clause 3. The occupant support of clause 2, any other suitable clause, or any suitable combination of clauses, including a cushion swivel system configured to control pivotable movement of the seat cushion relative to the seat foundation about a vertical pivot axis,
Clause 4. The occupant support of clause 3, any other suitable clause, or any suitable combination of clauses, the cushion swivel system including a swivel catch coupled to the seat foundation in a fixed position relative to the seat foundation.
Clause 5. The occupant support of clause 4, any other suitable clause, or any suitable combination of clauses, the cushion swivel system including a swivel latch coupled to the seat cushion for pivotable movement with the seat cushion.
Clause 6. The occupant support of clause 5, any other suitable clause, or any suitable combination of clauses, the cushion swivel system including a latch control system configured to control movement of the swivel latch between a locked position engaged with the swivel catch to block rotation of the seat cushion about the vertical axis, and an unlocked position separated from the swivel catch so that the seat cushion is free to pivot about the vertical axis.
Clause 7. The occupant support of clause 6, any other suitable clause, or any suitable combination of clauses, wherein the latch control system includes an actuator unit coupled with the swivel latch and configured to move the swivel latch from the locked position to the unlocked position, a latch retainer configured to engage the swivel latch in the unlocked position to block movement of the swivel latch from the unlocked position to the locked position, and/or an actuator control unit including an interface configured to receive user inputs and a controller configured to output: (i) a first command to at least one of the actuator unit and the latch retainer in response to a first user input to the interface to cause the actuator to move the swivel latch from the locked position to the unlocked position, and/or (ii) a second command to at least one of the actuator unit and the latch retainer in response to a second user input to the interface to cause the latch retainer to release the swivel latch so that the swivel latch can return to the locked position.
Clause 8. The occupant support of clause 7, any other suitable clause, or any suitable combination of clauses, wherein the actuator unit includes an actuator and the actuator is mounted to a side of the seat cushion to reside outside of a perimeter of the seat cushion defined by all sides of the seat cushion and spaced radially from the vertical axis.
Clause 9. The occupant support of clause 7, any other suitable clause, or any suitable combination of clauses, wherein the seat foundation includes a foundation plate and the seat cushion includes a cushion plate that interfaces with the foundation plate to provide a swivel interface therebetween and wherein the actuator unit includes an actuator and the actuator is offset radially from the swivel interface relative to the vertical axis.
Clause 10. The occupant support of clause 8, any other suitable clause, or any suitable combination of clauses, wherein the actuator unit further includes an actuator lever coupled to the actuator and actuator linkage coupled between the actuator lever and the swivel latch to transfer movement of the actuator to the swivel latch to move the swivel latch to the unlocked position in response to the first command.
Clause 11. The occupant support of clause 10, any other suitable clause, or any suitable combination of clauses, wherein the actuator is a linear actuator having an actuator piston configured to engage the actuator lever and pivot the actuator lever in response to the first command, and wherein the actuator linkage includes an actuator shaft coupled to the actuator lever and configured to translate linearly relative to the seat cushion in response to the first command and a second actuator lever coupled between the actuator shaft and the swivel latch and configured to pivot about a lever axis relative to the seat cushion in response to movement of the actuator shaft to cause pivotable movement of the swivel latch to the unlocked position.
Clause 12. The occupant support of clause 7, any other suitable clause, or any suitable combination of clauses, wherein the actuator unit includes an actuator cable connected to the swivel latch and configured to pull the swivel latch to the unlocked position in response to the first command.
Clause 13. The occupant support of clause 12, any other suitable clause, or any suitable combination of clauses, wherein the actuator unit includes a linear actuator having a linear piston coupled to the actuator cable and configured to move in a first direction in response to the first command to pull the actuator cable and cause the swivel latch to move to the unlocked position.
Clause 14. The occupant support of clause 13, any other suitable clause, or any suitable combination of clauses, wherein the latch retainer includes a first end configured to engage the swivel latch in the unlocked position and an opposite second end coupled to the linear piston of the actuator, and wherein the linear piston is configured to move in a second direction, opposite the first direction, in response to the second command to move the first end of the latch retainer away from the swivel latch.
Clause 15. The occupant support of clause 14, any other suitable clause, or any suitable combination of clauses, wherein the latch control unit further includes a return spring configured to bias the swivel latch toward the locked position so that the swivel latch returns to the locked position in response to the second command.
Clause 16. The occupant support of clause 13, any other suitable clause, or any suitable combination of clauses, wherein the actuator unit further includes a retainer cable coupled to the latch retainer, and wherein the linear piston is configured to move in a second direction, opposite the first direction, in response to the second command to pull the retainer cable to cause the latch retainer to pivot about a retainer pivot axis and disengage from the swivel latch.
Clause 17. The occupant support of clause 16, any other suitable clause, or any suitable combination of clauses, wherein the actuator unit further includes an actuator lever coupled to the seat cushion for pivotable movement relative to the seat cushion, the actuator lever having a first end coupled to the linear piston and to the actuator cable to pull the actuator cable in response to the first command and a second end coupled to the retainer cable to pull the retainer cable in response to the second command.
Clause 18. The occupant support of clause 12, any other suitable clause, or any suitable combination of clauses, wherein the actuator cable is made of a first shape-memory alloy that is configured to retract in length upon application of electrical energy from a power source to pull the swivel latch to the unlocked position in response to the first command, and the actuator further includes a retainer cable coupled to the latch retainer and made of a second shape-memory alloy that is configured to retract in length upon application of electrical energy from the power source to free the latch retainer from the swivel latch in response to the second command.
Clause 19. An occupant support for a vehicle, the occupant support including a seat foundation fixed in position relative to a floor of the vehicle.
Clause 20. The occupant support of clause 19, any other suitable clause, or any suitable combination of clauses, including a seat cushion adapted to support an occupant above the floor of the vehicle.
Clause 21. The occupant support of clause 20, any other suitable clause, or any suitable combination of clauses, including a cushion swivel system configured to control pivotable movement of the seat cushion relative to the seat foundation about a pivot axis.
Clause 22. The occupant support of clause 21, any other suitable clause, or any suitable combination of clauses, the cushion swivel system including a swivel catch.
Clause 23. The occupant support of clause 22, any other suitable clause, or any suitable combination of clauses, the cushion swivel system including a swivel latch.
Clause 24. The occupant support of clause 23, any other suitable clause, or any suitable combination of clauses, the cushion swivel system including a latch control system configured to control movement of the swivel latch between a locked position engaged with the swivel catch to block rotation of the seat cushion about the pivot axis, and an unlocked position separated from the swivel catch so that the seat cushion is free to pivot about the pivot axis.
Clause 25. The occupant support of clause 24, any other suitable clause, or any suitable combination of clauses, wherein the latch control system includes an actuator unit coupled with the swivel latch and configured to move the swivel latch from the locked position to the unlocked position, a latch retainer configured to engage the swivel latch in the unlocked position to block movement of the swivel latch from the unlocked position to the locked position, and an actuator control unit including an interface configured to receive user inputs and a controller configured to output one or more commands to cause movement of the actuator unit and the latch retainer to lock and unlock the swivel latch.
Clause 26. The occupant support of clause 25, any other suitable clause, or any suitable combination of clauses, wherein the latch retainer includes a retainer body and a retainer nose coupled to an end of the retainer body and arranged to lie at an angle relative to the retainer body.
Clause 27. The occupant support of clause 26, any other suitable clause, or any suitable combination of clauses, wherein the swivel latch includes a latch body and a latch nose configured to engage the latch catch in the locked position to block movement of the seat cushion relative to the seat foundation and configured to engage the retainer nose of the latch retainer in the unlocked position to block movement of the swivel latch from the unlocked position to the locked position.
Clause 28. The occupant support of clause 27, any other suitable clause, or any suitable combination of clauses, wherein the actuator unit includes an actuator lever coupled to the actuator and actuator linkage coupled between the actuator lever and the swivel latch to transfer movement of the actuator to the swivel latch to move the swivel latch to the unlocked position in response to the first command.
Clause 29. The occupant support of clause 28, any other suitable clause, or any suitable combination of clauses, wherein the actuator is a linear actuator having an actuator piston configured to engage the actuator lever and pivot the actuator lever in response to the first command, and wherein the actuator linkage includes an actuator shaft coupled to the actuator lever and configured to translate linearly relative to the seat cushion in response to the one or more commands and a second actuator lever coupled between the actuator shaft and the swivel latch and configured to pivot about a lever axis relative to the seat cushion in response to movement of the actuator shaft to cause pivotable movement of the swivel latch to the unlocked position.
Clause 30. The occupant support of clause 26, any other suitable clause, or any suitable combination of clauses, wherein the actuator unit includes a linear actuator having a linear piston configured to move: (i) in a first direction in response to a first command to cause movement of the swivel latch from the locked position to the unlocked position, and (ii) in an opposite, second direction in response to a second command to cause movement of the latch retainer to separate from the swivel latch so that the swivel latch is free to return to the locked position.
Clause 31. An occupant support for a vehicle, the occupant support including a seat foundation fixed in position relative to a floor of the vehicle,
Clause 32. The occupant support of clause 31, any other suitable clause, or any suitable combination of clauses, including a seat cushion adapted to support an occupant above the floor of the vehicle.
Clause 33. The occupant support of clause 32, any other suitable clause, or any suitable combination of clauses, including a cushion swivel system configured to control pivotable movement of the seat cushion relative to the seat foundation about a pivot axis.
Clause 34. The occupant support of clause 33, any other suitable clause, or any suitable combination of clauses, the cushion swivel system including a swivel catch.
Clause 35. The occupant support of clause 34, any other suitable clause, or any suitable combination of clauses, the cushion swivel system including a swivel latch movable relative to the swivel catch between a locked position engaged with the swivel catch to block rotation of the seat cushion about the pivot axis and an unlocked position separated from the swivel catch so that the seat cushion is free to pivot about the pivot axis.
Clause 36. The occupant support of clause 35, any other suitable clause, or any suitable combination of clauses, the cushion swivel system including a latch control system configured to provide means for controlling movement of the swivel latch: (i) from the locked position to the unlocked position in response to receipt of a first command, and (ii) from the unlocked position to the locked position in response to receipt of a second command to cause the swivel latch to remain in the locked position while that vehicle is in motion so that the occupant is free to pivot about the pivot axis with the seat cushion after receipt of the first command and before receipt of the second command without manually separating the swivel latch from the swivel catch.
Clause 37. The occupant support of clause 35, any other suitable clause, or any suitable combination of clauses, wherein the latch control system includes an actuator unit coupled with the swivel latch and configured to move the swivel latch from the locked position to the unlocked position and a latch retainer configured to engage the swivel latch in the unlocked position to block movement of the swivel latch from the unlocked position to the locked position.
Clause 38. The occupant support of clause 37, any other suitable clause, or any suitable combination of clauses, wherein the latch retainer includes a retainer body and a retainer nose coupled to an end of the retainer body and arranged to lie at an angle relative to the retainer body.
Clause 39. The occupant support of clause 38, any other suitable clause, or any suitable combination of clauses, wherein the swivel latch includes a latch body and a latch nose configured to engage the latch catch in the locked position to block movement of the seat cushion relative to the seat foundation and configured to engage the retainer nose of the latch retainer in the unlocked position to block movement of the swivel latch from the unlocked position to the locked position.
Clause 40. The occupant support of clause 39, any other suitable clause, or any suitable combination of clauses, wherein the actuator unit includes a linear actuator having a linear piston configured to move: (i) in a first direction in response to a first command to cause movement of the swivel latch from the locked position to the unlocked position, and (ii) in an opposite, second direction in response to a second command to cause movement of the latch retainer to separate the retainer nose from the latch nose so that the swivel latch is free to return to the locked position by a return spring.

1. An occupant support for a vehicle, the occupant support comprising:
a seat foundation fixed in position relative to a floor of the vehicle,
a seat cushion adapted to support an occupant above the floor of the vehicle, and
a cushion swivel system configured to control pivotable movement of the seat cushion relative to the seat foundation about a vertical pivot axis, the cushion swivel system comprising:
a swivel catch coupled to the seat foundation in a fixed position relative to the seat foundation,
a swivel latch coupled to the seat cushion for pivotable movement with the seat cushion, and
a latch control system configured to control movement of the swivel latch between a locked position engaged with the swivel catch to block rotation of the seat cushion about the vertical axis, and an unlocked position separated from the swivel catch so that the seat cushion is free to pivot about the vertical axis,
wherein the latch control system includes an actuator unit coupled with the swivel latch and configured to move the swivel latch from the locked position to the unlocked position, a latch retainer configured to engage the swivel latch in the unlocked position to block movement of the swivel latch from the unlocked position to the locked position, and an actuator control unit including an interface configured to receive user inputs and a controller configured to output: (i) a first command to at least one of the actuator unit and the latch retainer in response to a first user input to the interface to cause the actuator to move the swivel latch from the locked position to the unlocked position, and (ii) a second command to at least one of the actuator unit and the latch retainer in response to a second user input to the interface to cause the latch retainer to release the swivel latch so that the swivel latch can return to the locked position.

2. The occupant support of claim 1, wherein the actuator unit includes an actuator and the actuator is mounted to a side of the seat cushion to reside outside of a perimeter of the seat cushion defined by all sides of the seat cushion and spaced radially from the vertical axis.

3. The occupant support of claim 1, wherein the seat foundation includes a foundation plate and the seat cushion includes a cushion plate that interfaces with the foundation plate to provide a swivel interface therebetween and wherein the actuator unit includes an actuator and the actuator is offset radially from the swivel interface relative to the vertical axis.

4. The occupant support of claim 2, wherein the actuator unit further includes an actuator lever coupled to the actuator and actuator linkage coupled between the actuator lever and the swivel latch to transfer movement of the actuator to the swivel latch to move the swivel latch to the unlocked position in response to the first command.

5. The occupant support of claim 4, wherein the actuator is a linear actuator having an actuator piston configured to engage the actuator lever and pivot the actuator lever in response to the first command, and wherein the actuator linkage includes an actuator shaft coupled to the actuator lever and configured to translate linearly relative to the seat cushion in response to the first command and a second actuator lever coupled between the actuator shaft and the swivel latch and configured to pivot about a lever axis relative to the seat cushion in response to movement of the actuator shaft to cause pivotable movement of the swivel latch to the unlocked position.

6. The occupant support of claim 1, wherein the actuator unit includes an actuator cable connected to the swivel latch and configured to pull the swivel latch to the unlocked position in response to the first command.

7. The occupant support of claim 6, wherein the actuator unit includes a linear actuator having a linear piston coupled to the actuator cable and configured to move in a first direction in response to the first command to pull the actuator cable and cause the swivel latch to move to the unlocked position.

8. The occupant support of claim 7, wherein the latch retainer includes a first end configured to engage the swivel latch in the unlocked position and an opposite second end coupled to the linear piston of the actuator, and wherein the linear piston is configured to move in a second direction, opposite the first direction, in response to the second command to move the first end of the latch retainer away from the swivel latch.

9. The occupant support of claim 8, wherein the latch control unit further includes a return spring configured to bias the swivel latch toward the locked position so that the swivel latch returns to the locked position in response to the second command.

10. The occupant support of claim 7, wherein the actuator unit further includes a retainer cable coupled to the latch retainer, and wherein the linear piston is configured to move in a second direction, opposite the first direction, in response to the second command to pull the retainer cable to cause the latch retainer to pivot about a retainer pivot axis and disengage from the swivel latch.

11. The occupant support of claim 10, wherein the actuator unit further includes an actuator lever coupled to the seat cushion for pivotable movement relative to the seat cushion, the actuator lever having a first end coupled to the linear piston and to the actuator cable to pull the actuator cable in response to the first command and a second end coupled to the retainer cable to pull the retainer cable in response to the second command.

12. The occupant support of claim 6, wherein the actuator cable is made of a first shape-memory alloy that is configured to retract in length upon application of electrical energy from a power source to pull the swivel latch to the unlocked position in response to the first command, and the actuator further includes a retainer cable coupled to the latch retainer and made of a second shape-memory alloy that is configured to retract in length upon application of electrical energy from the power source to free the latch retainer from the swivel latch in response to the second command.

13. An occupant support for a vehicle, the occupant support comprising:
a seat foundation fixed in position relative to a floor of the vehicle,
a seat cushion adapted to support an occupant above the floor of the vehicle, and
a cushion swivel system configured to control pivotable movement of the seat cushion relative to the seat foundation about a pivot axis, the cushion swivel system comprising:
a swivel catch,
a swivel latch, and
a latch control system configured to control movement of the swivel latch between a locked position engaged with the swivel catch to block rotation of the seat cushion about the pivot axis, and an unlocked position separated from the swivel catch so that the seat cushion is free to pivot about the pivot axis,
wherein the latch control system includes an actuator unit coupled with the swivel latch and configured to move the swivel latch from the locked position to the unlocked position, a latch retainer configured to engage the swivel latch in the unlocked position to block movement of the swivel latch from the unlocked position to the locked position, and an actuator control unit including an interface configured to receive user inputs and a controller configured to output one or more commands to cause movement of the actuator unit and the latch retainer to lock and unlock the swivel latch.

14. The occupant support of claim 13, wherein the latch retainer includes a retainer body and a retainer nose coupled to an end of the retainer body and arranged to lie at an angle relative to the retainer body, and
wherein the swivel latch includes a latch body and a latch nose configured to engage the latch catch in the locked position to block movement of the seat cushion relative to the seat foundation and configured to engage the retainer nose of the latch retainer in the unlocked position to block movement of the swivel latch from the unlocked position to the locked position.

15. The occupant support of claim 14, wherein the actuator unit includes an actuator lever coupled to the actuator and actuator linkage coupled between the actuator lever and the swivel latch to transfer movement of the actuator to the swivel latch to move the swivel latch to the unlocked position in response to the first command.

16. The occupant support of claim 15, wherein the actuator is a linear actuator having an actuator piston configured to engage the actuator lever and pivot the actuator lever in response to the first command, and wherein the actuator linkage includes an actuator shaft coupled to the actuator lever and configured to translate linearly relative to the seat cushion in response to the one or more commands and a second actuator lever coupled between the actuator shaft and the swivel latch and configured to pivot about a lever axis relative to the seat cushion in response to movement of the actuator shaft to cause pivotable movement of the swivel latch to the unlocked position.

17. The occupant support of claim 13, wherein the actuator unit includes a linear actuator having a linear piston configured to move: (i) in a first direction in response to a first command to cause movement of the swivel latch from the locked position to the unlocked position, and (ii) in an opposite, second direction in response to a second command to cause movement of the latch retainer to separate from the swivel latch so that the swivel latch is free to return to the locked position.

18. An occupant support for a vehicle, the occupant support comprising:
a seat foundation fixed in position relative to a floor of the vehicle,
a seat cushion adapted to support an occupant above the floor of the vehicle, and
a cushion swivel system configured to control pivotable movement of the seat cushion relative to the seat foundation about a pivot axis, the cushion swivel system comprising:
a swivel catch,
a swivel latch movable relative to the swivel catch between a locked position engaged with the swivel catch to block rotation of the seat cushion about the pivot axis and an unlocked position separated from the swivel catch so that the seat cushion is free to pivot about the pivot axis, and
a latch control system configured to provide means for controlling movement of the swivel latch: (i) from the locked position to the unlocked position in response to receipt of a first command, and (ii) from the unlocked position to the locked position in response to receipt of a second command to cause the swivel latch to remain in the locked position while that vehicle is in motion so that the occupant is free to pivot about the pivot axis with the seat cushion after receipt of the first command and before receipt of the second command without manually separating the swivel latch from the swivel catch.

19. The occupant support of claim 18, wherein the latch control system includes an actuator unit coupled with the swivel latch and configured to move the swivel latch from the locked position to the unlocked position and a latch retainer configured to engage the swivel latch in the unlocked position to block movement of the swivel latch from the unlocked position to the locked position.

20. The occupant support of claim 19, wherein the latch retainer includes a retainer body and a retainer nose coupled to an end of the retainer body and arranged to lie at an angle relative to the retainer body,
wherein the swivel latch includes a latch body and a latch nose configured to engage the latch catch in the locked position to block movement of the seat cushion relative to the seat foundation and configured to engage the retainer nose of the latch retainer in the unlocked position to block movement of the swivel latch from the unlocked position to the locked position, and
wherein the actuator unit includes a linear actuator having a linear piston configured to move: (i) in a first direction in response to a first command to cause movement of the swivel latch from the locked position to the unlocked position, and (ii) in an opposite, second direction in response to a second command to cause movement of the latch retainer to separate the retainer nose from the latch nose so that the swivel latch is free to return to the locked position by a return spring.
